(19) United States
(12) Patent Application Publication
(10) Pub. No.: US 2009/0006162 A1
(43) Pub. Date: Jan. 1, 2009

(54) Workflows Leveraging Process Stages and Cross-Entity Records

(75) Inventors: Praveen Upadhyay, Bellevue, WA (US); Alexander Tkatch, Sammamish, WA (US); Noor Merchant, Redmond, WA (US)

Correspondence Address: MARSHALL, GERSTEIN & BORUN LLP (MICROSOFT), 233 SOUTH WACKER DRIVE, 6300 SEARS TOWER, CHICAGO, IL, 60606, US

(73) Assignee: MICROSOFT CORPORATION, Redmond, WA (US)

(21) Appl. No.: 11/770,818

(22) Filed: Jun. 29, 2007

(51) Int. Cl. G06F 9/46

(52) U.S. Cl. 705/8

(57) ABSTRACT

A system and method supporting an enhanced customer relationship management uses all system entities across all stages of a workflow to reduce or eliminate redundant data entry and allow creation of front-to-back workflows, e.g. lead-to-cash. Access to all levels of data allows customer service representatives to have access to previously inaccessible data, thus allowing better decision making at the point of contact. Use of an advanced query language used in report generation is re-used for setting the scope of workflow activities, so that complex criteria can be easily specified to have an activity run only when the specified criteria are met.

### BACKGROUND

Customer relationship management (CRM) systems have been in use to varying degrees. Known CRM systems require that each stage in a workflow process meet certain criteria before moving to a subsequent stage. If a criteria is changed or deleted during runtime processing, the workflow may halt or require restarting from the beginning.

Further, stage activity definitions are limited to the system entities associated with that stage. Creation of complex workflow activities may require custom programming that either requires special training or the use of trained consultants to develop such an activity. Even then, such complex workflow activities may run only to discover that no entities exist for which the activity is applicable.

### SUMMARY

A next generation of CRM system has the notion of re-settable steps for supplementing the workflow activities of broader workflow stages. The steps can be nested allowing greater flexibility in execution, including conditional exit criteria for a step. An expanded visibility into workflow system entities allows use of data from anywhere in the system to qualify an activity or to bring not just first tier data but second or third tier data into play in a workflow activity.

Similarly, expansion of access to workflow access to data allows creation of cross-entity workflow activities, such that an entire lead-to-cash set of workflow processes can be implemented. Because access to all system entity data is available from any point in the workflow, redundant data entry can be eliminated. Further, the query language used to generate rich reports from a variety of perspectives is used, in some cases verbatim, to generate workflow activities with inherent scoping, so that the activity only runs when the scope criteria are met. Because the activities use the query language already in common use, the development of scoped activities requires minimal training and lowers the dependence on specialist contractors.

### DRAWINGS

FIG. 1 is a block diagram of a computing system that may operate in accordance with the claims;

FIG. 2 is an illustration of a message-oriented API that may allow the users of the business application to execute business logic and access the business operation and data via messages;

### DESCRIPTION

Although the following text sets forth a detailed description of numerous different embodiments, it should be understood that the legal scope of the description is defined by the words of the claims set forth at the end of this patent. The detailed description is to be construed as exemplary only and does not describe every possible embodiment since describing every possible embodiment would be impractical, if not impossible. Numerous alternative embodiments could be implemented, using either current technology or technology developed after the filing date of this patent, which would still fall within the scope of the claims.

It should also be understood that, unless a term is expressly defined in this patent using the sentence “As used herein, the term ‘______’ is hereby defined to mean . . . ” or a similar sentence, there is no intent to limit the meaning of that term, either expressly or by implication, beyond its plain or ordinary meaning, and such term should not be interpreted to be limited in scope based on any statement made in any section of this patent (other than the language of the claims). To the extent that any term recited in the claims at the end of this patent is referred to in this patent in a manner consistent with a single meaning, that is done for sake of clarity only so as to not confuse the reader, and it is not intended that such claim term by limited, by implication or otherwise, to that single meaning. Finally, unless a claim element is defined by reciting the word “means” and a function without the recital of any structure, it is not intended that the scope of any claim element be interpreted based on the application of 35 U.S.C. §112, sixth paragraph.

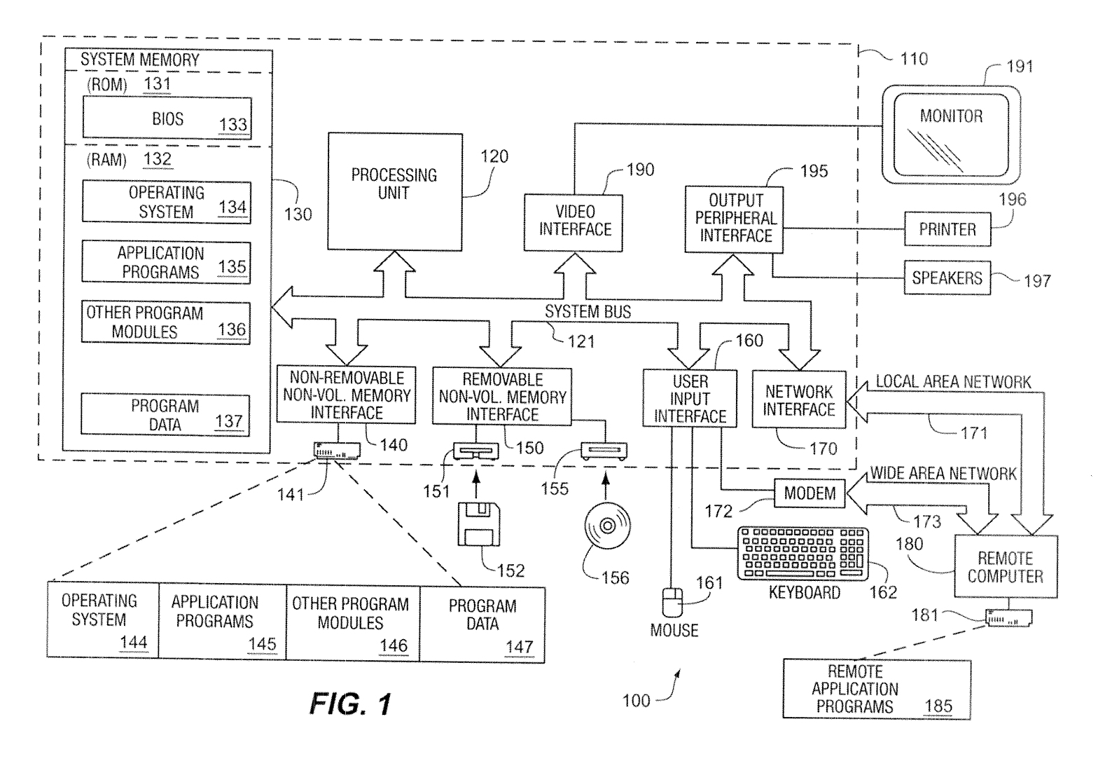

FIG. 1 illustrates an example of a suitable computing system environment 100 on which a system for the steps of the claimed method and apparatus may be implemented. The computing system environment 100 is only one example of a suitable computing environment and is not intended to suggest any limitation as to the scope of use or functionality of the method of apparatus of the claims. Neither should the computing environment 100 be interpreted as having any dependency or requirement relating to any one or combination of components illustrated in the exemplary operating environment 100.

With reference to FIG. 1, an exemplary system for implementing the steps of the claimed method and apparatus includes a general purpose computing device in the form of a computer 110. Components of computer 110 may include, but are not limited to, a processing unit 120, a system memory 130, and a system bus 121 that couples various system components including the system memory to the processing unit 120. The system bus 121 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

Computer 110 typically includes a variety of computer readable media. Computer readable media can be any available media that can be accessed by computer 110 and includes both volatile and nonvolatile media, removable and non-removable media. By way of example, and not limitation, computer readable media may comprise computer storage media and communication media. Computer storage media includes both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by computer 110. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer readable media.

The system memory 130 includes computer storage media in the form of volatile and/or nonvolatile memory such as read only memory (ROM) 131 and random access memory (RAM) 132. A basic input/output system 133 (BIOS), containing the basic routines that help to transfer information between elements within computer 110, such as during start-up, is typically stored in ROM 131. RAM 132 typically contains data and/or program modules that are immediately accessible to and/or presently being operated on by processing unit 120. By way of example, and not limitation, FIG. 1 illustrates operating system 134, application programs 135, other program modules 136, and program data 137.

The computer 110 may also include other removable/non-removable, volatile/nonvolatile computer storage media. By way of example only, FIG. 1 illustrates a hard disk drive 141 that reads from or writes to non-removable, nonvolatile magnetic media, a magnetic disk drive 151 that reads from or writes to a removable, nonvolatile magnetic disk 152, and an optical disk drive 155 that reads from or writes to a removable, nonvolatile optical disk 156 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 141 is typically connected to the system bus 121 through a non-removable memory interface such as interface 140, and magnetic disk drive 151 and optical disk drive 155 are typically connected to the system bus 121 by a removable memory interface, such as interface 150.

The drives and their associated computer storage media discussed above and illustrated in FIG. 1, provide storage of computer readable instructions, data structures, program modules and other data for the computer 110. In FIG. 1, for example, hard disk drive 141 is illustrated as storing operating system 144, application programs 145, other program modules 146, and program data 147. Note that these components can either be the same as or different from operating system 134, application programs 135, other program modules 136, and program data 137. Operating system 144, application programs 145, other program modules 146, and program data 147 are given different numbers here to illustrate that, at a minimum, they are different copies. A user may enter commands and information into the computer 20 through input devices such as a keyboard 162 and pointing device 161, commonly referred to as a mouse, trackball or touch pad. Other input devices (not shown) may include a microphone, joystick, game pad, satellite dish, scanner, or the like. These and other input devices are often connected to the processing unit 120 through a user input interface 160 that is coupled to the system bus, but may be connected by other interface and bus structures, such as a parallel port, game port or a universal serial bus (USB). A monitor 191 or other type of display device is also connected to the system bus 121 via an interface, such as a video interface 190. In addition to the monitor, computers may also include other peripheral output devices such as speakers 197 and printer 196, which may be connected through an output peripheral interface 190.

The computer 110 may operate in a networked environment using logical connections to one or more remote computers, such as a remote computer 180. The remote computer 180 may be a personal computer, a server, a router, a network PC, a peer device or other common network node, and typically includes many or all of the elements described above relative to the computer 110, although only a memory storage device 181 has been illustrated in FIG. 1. The logical connections depicted in FIG. 1 include a local area network (LAN) 171 and a wide area network (WAN) 173, but may also include other networks. Such networking environments are commonplace in offices, enterprise-wide computer networks, intranets and the Internet.

When used in a LAN networking environment, the computer 110 is connected to the LAN 171 through a network interface or adapter 170. When used in a WAN networking environment, the computer 110 typically includes a modem 172 or other means for establishing communications over the WAN 173, such as the Internet. The modem 172, which may be internal or external, may be connected to the system bus 121 via the user input interface 160, or other appropriate mechanism. In a networked environment, program modules depicted relative to the computer 110, or portions thereof, may be stored in the remote memory storage device. By way of example, and not limitation, FIG. 1 illustrates remote application programs 185 as residing on memory device 181. It will be appreciated that the network connections shown are exemplary and other means of establishing a communications link between the computers may be used.

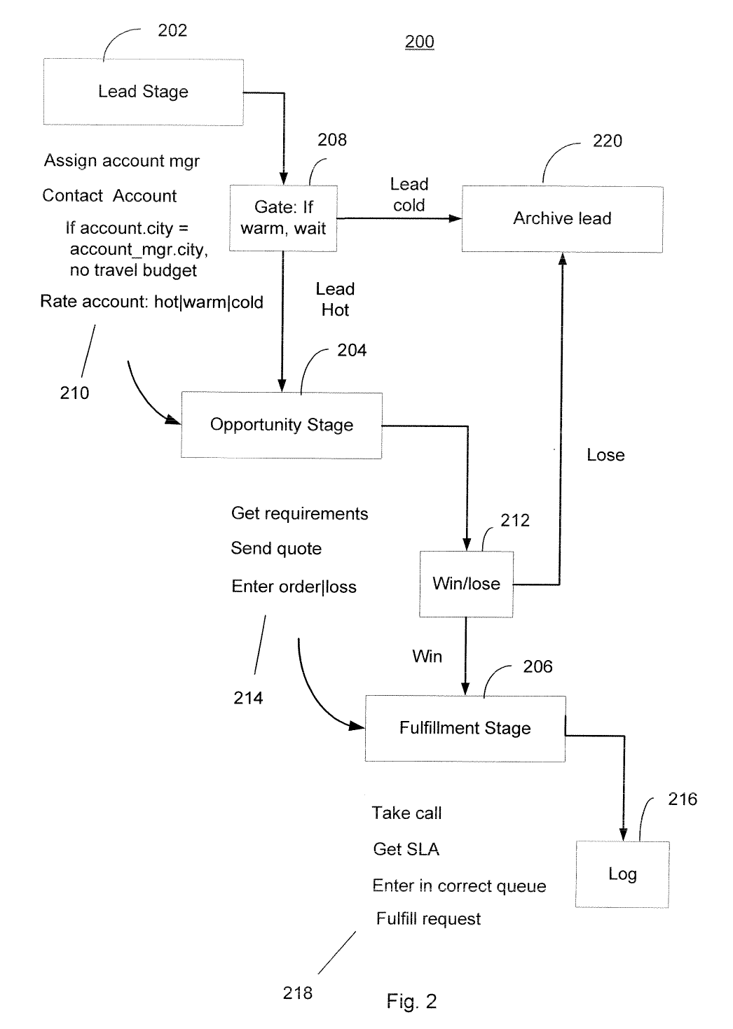

171 FIG. 2 is a flow chart of an exemplary workflow process 200 that allows management of stages in a process using conditional steps. The workflow process illustrated is indicative of a customer relationship management (CRM) flow. Main stages of the workflow process 200 include a lead stage 202, an opportunity stage 204 and a fulfillment stage 206. The workflow process is contrasted from previous versions by allowing development of conditional statements using any data in the workflow database, by adding combinatorial steps to the workflow stages, cross stage workflows, and complex conditional statements for evaluating stage exit criteria.

CRM entities can be classified into two major categories. The first represents work to be assigned to an individual, in one embodiment, an “activity.” The second are database records such as system entities or custom entities. Roughly, the latter are nouns and the former are verbs. A basic CRM system allows the combination of activities and entities to create workflows, or requirements for activities to be performed on entities to produce a result that triggers another activity. A rudimentary workflow may allow creation of workflow actions such as specifying a phone call or completion of a task, particularly those associated with only one stage.

A richer, more robust CRM system, such as one in accordance with the current disclosure, may allow creation of workflow activities on virtually any system entity associated with any stage in a process. Thus, rich workflows can be created that allow complete business processes to be modeled and used to track activities from front to back or from lead to cash. Some sample system entities that may be used to create rich, cross-entity workflows may include: Account, Appointment, Campaign, Campaign Activity, Campaign Response, Case, Competitor, Contact, Contract, Currency, Discount List, E-mail, Facility/Equipment, Fax, Invoice, Lead, Letter, Marketing List, Opportunity, Order, Phone Call, Price List, Product, Queue, Quote, Sales Literature, Service Activity, Site, Task, and Territory.

To illustrate these contrasts in no particular order, the workflow of FIG. 2 is used. Each of the three stages 202, 204, 206 illustrated has steps associated with completion of the stage, as described below. When the conditions in each of the steps is met, processing may continue at the next stage. When the final stage is completed, wrap-up activities may be executed and the particular instance of the workflow may be closed.

The exemplary workflow process 200 may be used to capture tracking and reporting for a typical lead-to-cash sales cycle, beginning with development of a lead, or sales contact, and finishing with the deliver of a product to lead, now a customer. At the lead stage 202, a telephone inquiry or cold call may develop into a possible contact or lead. Gating criteria 208 for passing from the lead stage 202 to the opportunity stage 204 may include individual steps 210. The workflow process 200, stages 202, 204, 206 and steps for each stage, such as steps 210 for the lead stage 202 may be defined by a workflow template (not depicted). The template, and therefore the particular instance activated for each lead, may include steps determined to be relevant to successful completion of the process of developing good prospects, recognizing and leaving behind bad prospects, and winning competitive business. The template for a given process may include management flags that specify whether steps are allowed in a stage. Flags may also be set in the template that specify if specific security criteria must be met for a step to be modified during processing.

However, the actual business interactions often do not follow a template, and it may be desirable to repeat or skip particular steps without abandoning the overall flow of the template process.

The steps 210 in the illustrated lead stage 202 may include assigning an account manager or salesperson, contacting the account, and rating the account. An additional step, or sub-step, shown for the lead stage 202 may be a conditional rule for managing the Contact Account step. That is, if the account is in a city (account.city) where the assigned salesperson works from (account_mgr.city) then no travel budget will be approved for contacting the account.

The account may be rating on a 1-10 scale, or as illustrated in FIG. 2, simply as hot, medium, or cold. To pass the gate 208, each of the first two must be completed in order, and the account must be rated as hot. For example, the account must have approved budget for a current project out for bid, and the account manager would rate the account as hot, causing the gate 208 to trigger. Operation may then pass to the opportunity stage 204. Associated data about the account and the quote are available to steps in the opportunity stage because cross-entity data, i.e. all entity data, is available from anywhere in the workflow process 200. Data fields in later steps may be automatically populated using data generated in prior stages or steps.

If the account is rated warm, the workflow process 200 will remain at the lead stage 202 until a change occurs.

If the account is rated cold, for example, if the account does not buy products from the company's line, the account may be rated cold and processing passed to an archive stage 220. At the archive stage, the account information and notes may be stored, should the account be contacted again, the history can be reviewed and the account questioned regarding a change in business that might prompt renewing contacts.

At the opportunity stage 204, information passed from the lead stage 202 may be used to populate information about the account developed at the lead stage 202 and set up additional steps related to completion of the opportunity stage 204. Sample steps 214 from the opportunity stage may include getting requirements and sending a quote. The gate 212 may use as exit criteria winning or losing the current bid. If the bid is lost, the workflow process may continue at block 220, and the opportunity may be archived with information about the bid and the loss, such as competitive information.

Additional steps associated with gating actions 208, 212, 216 may include notifications, including email messages, to people involved in the current stage, the subsequent stage, or both. The notification may include stage metrics, account or bid status, personnel, status of exit criteria, etc.

If the bid is won, the workflow process 200 may continue to the fulfillment stage 206. At the fulfillment stage, order processing and customer service steps 218 may be used to drive the preparation of the order goods or services, shipping, billing and collection. Customer service steps 218 may illustrate a customer service call, where the call is taken, and the customer's service level agreement is brought up. If a premium account, the customer request may enter a guaranteed response time queue, while a standard account may go into a standard queue. Cross-record matching may also be used to evaluate call criteria. For example, if a call is received, first tier records related to the account may be automatically retrieved. At the same time, second tier data about the account and rules-driven processing related to the second tier data may also be retrieved. That is, information related to the account can be used to further trigger rules or display information for the call taker. For example, the identity of the calling party may be matched to extended data about the account. When the call is from the president of the company, the call may be routed to a senior sales person.

Care must be taken that the extended data retrieval and rules execution must not fail at runtime. For example, error handling for irretrievable data must be in place. Modeling may also be used to ensure that conflicting execution conditions are handled appropriately. To illustrate, a set of rules may be in place for any call from the previously mentioned customer to be routed to accounts receivable, while the rule regarding calls from the president may still be active. Firing both rules should not cause an error. In one embodiment, the most recent rule is executed and other rules are ignored.

When the customer service steps 218 have completed, that is, the order ships and payment is received, the final gate 216 may be executed and the information related to the order logged. Because entity data is available to all stages, the logging process may be a simple marking of status at a point in time. Account data may be maintained for use in processing subsequent leads from that account. Specific data on the sale itself may be maintained for verifying warranty work related the recently sold item or for scheduling routine maintenance.

In some implementations of workflow processes, moving or overriding a gating activity can cause subsequent processes to be deleted. The implementation of steps described above allow a separation of the gating activities, e.g. steps 210, from the ultimate processing associated with leaving the stage, e.g. gate 208. Therefore, if an individual step is moved or over-ridden, the activity may be set as a pass or fail for the purpose of future processing. If other steps have not been completed, their state may be evaluated normally. As shown, steps may be nested, requiring completion of one or more sub-steps before the higher level step is evaluated as having succeeded.

When passing from stage to stage, data developed in the current stage can be used to populate fields in the next stage, such as, due dates from a quote activity can be used to populate fulfillment activities, as opposed to prior art systems requiring manual re-entry of such data between stages.

Another feature of steps is the ability to report status of each step including not only a specific instance of the workflow process, but all concurrent workflow processes at that stage. For example, a report of all items in the opportunity stage 204 having completed the send quote stage can be reported. Further, if confidence is tracked, a pareto by confidence can be generated for all items having completed the ‘send quote’ step. Additional data about steps can be generated and tracked, such as a report by time in state or time in step.

Because any data element is available for reporting, a wide variety of report topics may be generated, allowing analysis by product, by customer, by salesperson, etc. Those familiar with relational databases are used to being able to write complex requests to return specific data. A CRM system in accordance with the current disclosure allows the use of the same relational conditions to set the scope of a workflow event.

Scoping a workflow event using relational criteria allows a very rich set of workflow events to be created and run only when the relational criteria are met. For example, a report criteria may include a list of all accounts with open sales opportunities for OEM equipment from the western sales region having greater than 75% confidence of closing. A corresponding workflow activity may be created that allows assignment of those same opportunities to a regional manager for an email contact with the account representatives. Because the workflow activity is pre-qualified, if the criteria are not met, the activity will not run. To continue the example, if no leads for OEM equipment in the western sales region meet the confidence level criteria, the activity may not run, sparing the regional manager an email with an activity assignment having no entries.

Using the same query language to build both report criteria and workflow process criteria allows ‘cut and paste’ interactivity for both reports and CRM events. This allows a considerable savings in both user training and implementation of individual workflow creation.

The expansion of CRM activities to include moveable and re-settable steps allows complex workflow activities to be created, while maintaining the flexibility to accommodate real-world changes without exiting or restarting an entire stage or workflow process. Further, the ability to access all related data from system gives the CRM system users flexibility to build special case handling into a baseline workflow, such as that call from the president of a company. Cross-entity, or cross-stage workflows can leverage data generated in a previous stage to provide a richer and more efficient user experience that translates into higher employee productivity, focusing more user time on customers rather than internal systems. Lastly, the use of advanced query language to create not only reports, but to set workflow activity definitions creates an efficient use of employee training while helping to ensure that only activities that meet the required scope are actually executed.

Although the forgoing text sets forth a detailed description of numerous different embodiments, it should be understood that the scope of the patent is defined by the words of the claims set forth at the end of this patent. The detailed description is to be construed as exemplary only and does not describe every possible embodiment because describing every possible embodiment would be impractical, if not impossible. Numerous alternative embodiments could be implemented, using either current technology or technology developed after the filing date of this patent, which would still fall within the scope of the claims.

Thus, many modifications and variations may be made in the techniques and structures described and illustrated herein without departing from the spirit and scope of the present claims. Accordingly, it should be understood that the methods and apparatus described herein are illustrative only and are not limiting upon the scope of the claims.

1. A method of managing activities in a customer relationship management (CRM) system comprising:
activating a workflow stage;
retrieving information in a first tier record corresponding to the workflow stage;
retrieving information in a second tier record referenced by the first tier record;
performing a conditional process according to a content of the second tier record;
activating a step in the workflow stage comprising:
activating a gating activity for the workflow stage;
monitoring for a status change of the gating activity;
signaling the workflow stage after completion of the gating activity;
activating a second workflow stage that conditionally monitors for an event; and
activating a third workflow stage selected from a set of workflow stages according to the event.

2. The method of claim 1, further comprising:
passing activity parameters from the second workflow stage to the third workflow stage.

3. The method of claim 1, further comprising:
reporting a status of the gating activity responsive to a query.

4. The method of claim 1, further comprising:
qualifying an entrance criteria before triggering the event.

5. The method of claim 4, wherein qualifying the entrance criteria comprises evaluating one or more conditions related to a scope of the event.

6. The method of claim 4, wherein qualifying the entrance criteria comprises applying a compound find query.

7. The method of claim 4, wherein qualifying the entrance criteria comprises applying a compound find query copied from one of another workflow stage or an advanced find query.

8. The method of claim 1, further comprising:
reporting a status of the gating activity responsive to a query.

9. The method of claim 7, wherein the reporting the status of the gating activity responsive to the query comprises reporting the status of the gating activity based on a role assigned to an entity initiating the query.

10. The method of claim 1, wherein the second tier record is outside a parent/child relationship with the first tier record.

11. The method of claim 1, further comprising:
reading a metadata flag allowing creation of a record in a workflow stage.

12. A computer-readable medium having computer-executable instructions implementing a method of implementing a workflow management process having high-level stages and steps within the stages, the method comprising:
activating a stage;
determining when a step is allowed in the stage;
determining when a first criteria for entering the step has been met;
entering the step;
determining when a second criteria for exiting the step has been met;
storing metrics corresponding to the step, the metrics including start time and end time;
storing step-related data for use by a subsequent workflow stage;
activating the subsequent workflow stage; and
sending a notification to a stage participant regarding the activation of the subsequent workflow stage.

13. The computer-readable medium of claim 12, wherein the step comprises a plurality of nested steps.

14. The computer-readable medium of claim 12, further comprising generating a time-in-step report using the start time and end time.

15. The computer-readable medium of claim 12, wherein determining when a step is allowed in a stage comprises determining when a corresponding management flag is set.

16. The computer-readable medium of claim 12, further comprising scoping a step to occur only when a set of conditions is true.

17. The computer-readable medium of claim 16, wherein the set of conditions is defined by a report query language statement.
